(19) United States
(12) Patent Application Publication
(10) Pub. No.: US 2023/0128781 A1
(43) Pub. Date: Apr. 27, 2023

(54) Trackable Cup Device

(71) Applicant: James Douglas, Stonecrest, GA (US)

(72) Inventor: James Douglas, Stonecrest, GA (US)

(21) Appl. No.: 17/937,523

(22) Filed: Oct. 3, 2022

Related U.S. Application Data
(60) Provisional application No. 63/270,137, filed on Oct. 21, 2021.

(51) Int. Cl. A61J 9/00; A47G 19/22; G08C 17/02; H04W 4/029

(52) U.S. Cl. CPC A61J 9/00; A47G 19/2227; G08C 17/02; H04W 4/029; A47G 2019/2244

(57) ABSTRACT

The present invention relates to a trackable cup device for locating a user's lost cup through electronic communication with a transmitter in a remote, and a receiver in a base member. The device is comprised of body, a top member, a base member, and a remote. The top member is primarily comprised of at least one nozzle, at least one opening, and at least one fastener. The base member is further comprised of at least one receiver, at least one speaker, and at least one battery. The remote is comprised of at least one transmitter, at least one microphone, and at least one battery. Further, the device allows a user to play prerecorded messages or sounds through the speakers to calm their children.

### CROSS-REFERENCE TO RELATED APPLICATION

The present application claims priority to, and the benefit of, U.S. Provisional Application No. 63/270,137, which was filed on Oct. 21, 2021, and is incorporated herein by reference in its entirety.

### FIELD OF THE INVENTION

The present invention relates generally to the field of cups. More specifically, the present invention relates to a trackable cup device for locating a user's lost cup through electronic communication with a transmitter in a remote, and a receiver in a base member. The device is comprised of body, a top member, a base member, and a remote. The top member is primarily comprised of at least one nozzle, at least one opening, and at least one fastener. The base member is further comprised of at least one receiver, at least one speaker, and at least one battery. The remote is comprised of at least one transmitter, at least one microphone, and at least one battery. Further, the device allows a user to play prerecorded messages or sounds through the speakers to calm their children. Accordingly, the present disclosure makes specific reference thereto. Nonetheless, it is to be appreciated that aspects of the present invention are also equally applicable to other like applications, devices, and methods of manufacture.

### BACKGROUND

Toddlers and young children often cause spills and other messes when they are consuming liquids due to their limited manual dexterity. Because of the risk of spills, young children often consume liquids through a “sippy cup”. Sippy cups prevent liquid from spilling if the cup is dropped or knocked over. Even though sippy cups help reduce the probability of a spill occurring, they do not stop a child from knocking the cup over or tossing the cup to the ground. This can lead to a sippy cup becoming lost or broken. Some children have a favorite cup that they use often. If this cup is lost or misplaced, it may be difficult for the parents to get their child to use a different cup. This can lead to parents wasting time looking for the lost or misplaced cup, as well as wasting time trying to get their child to use a different cup.

Therefore, there exists a long-felt need in the art for an improved cup for young children. Further, there exists a long-felt need in the art for a cup that is trackable such that it does not become lost or misplaced. There also exists a long-felt need in the art for a trackable cup device that has a prerecorded message that can play through a speaker to calm a child. There also exists a long-felt need in the art for a trackable cup device that can be located by using a remote. Further, there exists a long-felt need in the art for a trackable cup device that prevents parents from spending large amounts of time looking for their child's cup.

The subject matter disclosed and claimed herein, in one embodiment thereof, comprises a trackable cup device. The device is comprised of body, a top member, a base member, and a remote. The top member is primarily comprised of at least one nozzle, at least one opening, and at least one fastener. The base member is further comprised of at least one receiver, at least one speaker, and at least one battery. The remote is comprised of at least one transmitter, at least one microphone, and at least one battery. The device allows a user to be able to locate their missing cup without spending large amounts of time searching for it. Further, the device allows a user to play prerecorded messages or sounds through the speakers to calm their children.

In this manner, the trackable cup device of the present invention accomplishes all of the foregoing objectives and provides a novel trackable cup device that provides users with a way to locate their lost device. The device also allows a user to be able to play prerecorded messages or sounds through the speakers for their children.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a trackable cup device. The device is primarily comprised of a body, at least one top member, at least one base member, and at least one remote. The body of the device is comprised of an interior space that houses the liquid. In the preferred embodiment, the body may be comprised of at least one grip area that allows a child to hold onto the device effectively. In a differing embodiment, the grip area may be in the form of at least one handle. The handle provides a smaller area for the child to hold onto to prevent dropping the device.

The device is comprised of at least one top member. The top member may be comprised of at least one fastener that attaches the top member to the body. The fastener attaches to the reciprocating fastener located on the body of the device. The top member may be comprised of at least one gasket that is located on the inside of the top member to prevent liquid from leaking out through the fasteners.

The top member may also be comprised of at least one nozzle. The nozzle allows a user to suck liquid through the device. The nozzle further is comprised of at least one opening located on the top of the nozzle. The opening is in fluid communication with the top member and the body of the device. When the user sucks through the nozzle, the liquid in the internal space of the body is pulled through the top member and through the openings on the nozzle. In one embodiment, the top member is comprised of at least one valve that blocks the liquid from spilling out the openings of the nozzle when the user is not trying to use the device.

In another embodiment, the top member is comprised of a cap that closes over the top member, thereby preventing any liquid from spilling while the device is not in use. The cap is opened and closed via at least one hinge positioned on the top member. In this embodiment, the top member is comprised of at least one fastener that attaches to the reciprocating fastener positioned on the cap. Further, the top member may be comprised of at least one button.

The device further may be comprised of at least one base member. The base member may be comprised of a non-slip base grip positioned on the bottom of the base member to further prevent the device from falling over. Further, the base member is attachable and detachable from the body via at least one fastener.

The base member is comprised of at least one receiver positioned within the interior space of the base member. The receiver is in electrical communication with the transmitter located in the remote. This allows the transmitter to communicate with the receiver, which then communicates with the speaker. The speaker then plays the desired sound that the user selected on the remote. The speaker and the receiver are both powered by at least one battery. In one embodiment, the battery may be recharged via a charging port.

The device is comprised of at least one remote, comprised of at least one recording button, at least one location button, at least one transmitter, at least one battery, at least one microphone, and at least one charging port. Further, the transmitter is in electrical communication with the receiver located in the base member. The remote further is comprised of at least one recording button. The recording button when pressed, makes the transmitter communicate with the receiver. The receiver then communicates with the speaker, which then plays a prerecorded audio sound through the speakers. The audio sound may be recorded via at least one microphone positioned in the remote. The microphone and the recording feature allow a parent to be able to record anything they wish to play through the device.

The remote may also be comprised of at least one location button. The location button communicates with the device via transmitter and receiver. The device then plays a sound through the speakers that allow the user to follow the sound and locate the lost device. Further, the remote is comprised of at least one battery that supplies power to the remote. In one embodiment, the battery may be recharged via at least one charging port.

Accordingly, the trackable cup device of the present invention is particularly advantageous as it provides a user with a means of locating their child's lost cup. Further, the device provides a way for the parent to play prerecorded sounds through the device to help soothe their child. In this manner, the trackable cup device overcomes the limitations of existing cups known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a trackable cup device of the present invention in accordance with the disclosed architecture;

FIG. 2 illustrates an enhanced perspective view of one potential embodiment of a trackable cup device of the present invention in accordance with the disclosed architecture; and

FIG. 3 illustrates a perspective view of one potential embodiment of a remote for a trackable cup device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved cup for young children. Further, there exists a long-felt need in the art for a cup that is trackable, so it does not become lost or misplaced. There also exists a long-felt need in the art for a trackable cup device that has prerecorded message that can play through a speaker to calm a child. There also exists a long-felt need in the art for a trackable cup device that can be located by using a remote. Further, there exists a long-felt need in the art for a trackable cup device that prevents parents from spending large amounts of time looking for their child's cup.

The present invention, in one exemplary embodiment, is comprised of a trackable cup device. The device is primarily comprised of a cup, comprised of a body, at least one top member, and at least one base member. The base member is comprised of at least one receiver, at least one speaker, and at least one battery. The top member is comprised of at least one nozzle, at least one fastener, at least one valve, and at least one opening. The device is also comprised of at least one remote, further comprised of at least one transmitter, at least one microphone, at least one battery, at least one location button, and at least one recording button.

Further, the transmitter of the remote, and the receiver of the base member are in wireless electrical communication to allow a user to determine the location of the mislaid/lost device. This allows the user to locate their missing device conveniently, as well as be able to play recorded messages and sounds through the device to soothe their children.

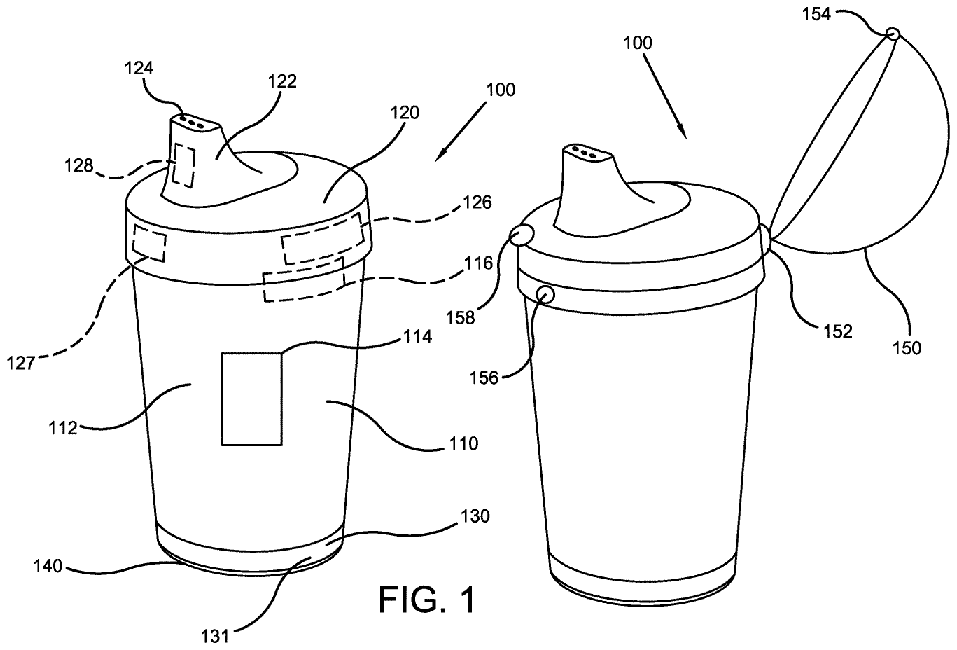

Referring initially to the drawings, FIG. 1 illustrates a perspective view of one potential embodiment of a trackable cup device 100 of the present invention in accordance with the disclosed architecture. The device 100 is primarily comprised of a body 110, at least one top member 120, at least one base member 130, and at least one remote 200. The body 110 of the device 100 is comprised of an interior space 112 that houses a liquid. The body 110 may further be made from a plurality of materials such as, but not limited to, metal or plastic. In the preferred embodiment, the body may be manufactured from a rigid durable plastic such as, but not limited to, acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc.

In the preferred embodiment, the body 110 may be comprised of at least one grip area 114 that allows a child to hold onto the device 100 effectively. In one embodiment, the grip area may be a non-slip rubber material such as, but not limited to, neoprene, silicone, nitrile, EPDM, styrene-butadiene, butyl, natural, fluorosilicone, natural rubbers, neoprene rubber elastomer, silicone rubber elastomer, ethylene propylene diene monomer rubber, butyl rubber, nitrile rubber, buna-n rubber, styrene-butadiene rubber elastomers, viton rubber elastomer, diaphragm rubber, thermoplastic rubber, etc. In a differing embodiment, the grip area 114 may be in the form of at least one handle. The handle provides a smaller area for the child to hold onto to prevent dropping the device 100.

The device 100 is also comprised of at least one top member 120. The top member is preferably manufactured from any rigid plastic material known in the art. The top member 120 may be comprised of at least one fastener 126 that allows the top member 120 to attach to the body 110. The fastener 126 attaches to a reciprocating fastener 116 located on the body 110 of the device 100. The fasteners 116,126 may be a plurality of fastener types such as, but not limited to, threaded fasteners, snap-cap fasteners, magnetic, adhesive, etc. The top member 120 may also be comprised of at least one gasket 127 that is located on the inside of the top member 120 to prevent liquid from leaking out through the fasteners 116, 126 during use. In the preferred embodiment, the gasket 127 is manufactured from any rubber material known in the art. In differing embodiments, the gasket 127 may be any gasket known in the art such as, but not limited to: chloroprene gasket, silicone gasket, ethylene propylene diene monomer gasket, etc.

The top member 120 may also be comprised of at least one nozzle 122. The nozzle 122 is where the user sucks the liquid from the device 100. The nozzle 122 further is comprised of at least one opening 124 located on the top of the nozzle 122. The opening 124 is in fluid communication with the top member 120 and the body 110 of the device 100. When the user sucks through the nozzle 122, the liquid in the internal space 112 of the body 110 is pulled through the top member 120 and through the opening 124 on the nozzle 122. In one embodiment, the top member 100 is comprised of at least one valve 128 that blocks the liquid from spilling out the opening 124 of the nozzle 122 when the user is not trying to use the device 100. When the user sucks through the nozzle 122, the valve 128 allows liquid to pass through the valve 128.

In another embodiment, the top member 120 is comprised of a cap 150 that closes over the top member 120 preventing any liquid from spilling while the device 100 is not in use. The cap 150 is opened and closed via at least one hinge 152 positioned on the top member 120. There are a plurality of hinges that may be used such as, but not limited to, an offset blind hinge, a knuckle hinge, a butt hinge, a rising butt hinge, a gravity pivot hinge, a ball bearing hinge, a barrel hinge, a concealed hinge, a knife hinge, a piano hinge, a strap hinge, a pivot hinge, a gas-piston hinge, an injection molded hinge, a locking hinge, etc. In this embodiment, the top member 120 is comprised of at least one fastener 158 that attaches to a reciprocating fastener 154 positioned on the cap 150. This allows for the cap 150 to be fastened to the top member 120 preventing spills. The fasteners 154, 158 may be any fastener type known in the art. Further, the top member may be comprised of at least one button 156. The button 156 is pressed by the user disengaging the fasteners 154, 158 and allowing the cap 150 to be opened.

The device 100 may be comprised of at least one base member 130. The base member 130 is comprised of an interior space 131 that houses a multitude of components. The base member 130 also may be comprised of a non-slip base grip 140 positioned on the bottom of the base member 130 to further prevent the device 100 from falling over. The non-slip base grip 140 may be manufactured from any non-slip rubber material known in the art.

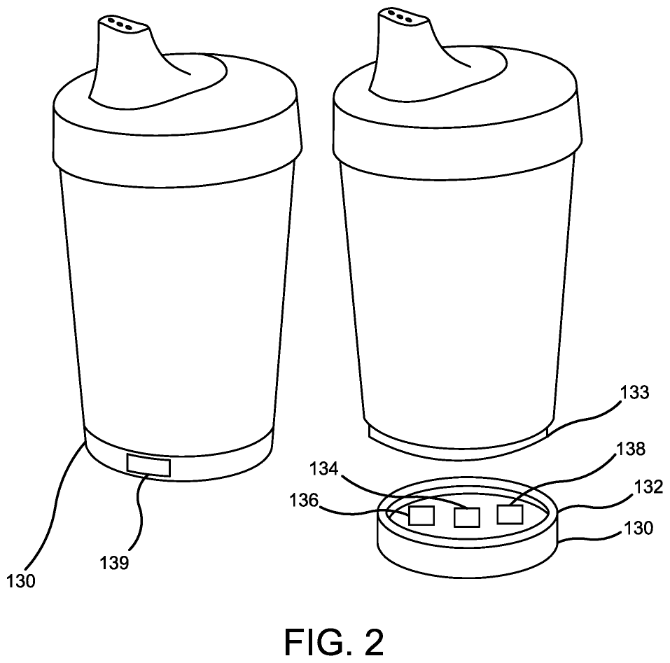

FIG. 2 illustrates an enhanced perspective view of one potential embodiment of a trackable cup device 100 with the base member detached of the present invention in accordance with the disclosed architecture. The base member 130 may be comprised of at least one fastener 132, at least one speaker 138, at least one receiver 134, at least one battery 136, and at least one charging port 139.

The base member 130 is preferably manufactured from any rigid plastic material known in the art. Further, the base member 130 is attachable and detachable from the body 110. The base member 130 may be comprised of at least one base fastener 132 positioned inside the base member 130. The base fastener 132 is fastened to a reciprocating body fastener 133 positioned on the bottom of the body 110. These fasteners 132, 133 may be a plurality of fastener types such as, but not limited to: threaded fastener, magnetic fastener, snap cap fastener, hook and loop, tongue and groove, adhesive, etc.

The base member 130 is further comprised of at least one receiver 134 positioned within the interior space 131 of the base member 130. The receiver 134 may be any receiver known in the art. The receiver 134 is in electrical communication with at least one transmitter 220 located in the remote 200. This allows for the transmitter 220 to wirelessly communicate with the receiver 134, which then wirelessly communicates with the speaker 138. The speaker 138 then plays the desired sound that the user selected on the remote 200.

The base member 120 is comprised of at least one speaker 138. The speaker 138 may be any speaker known in the art. The speaker 138 and the receiver 134 are both powered by at least one battery 136. The battery 136 can be in the form of an alkaline, nickel-cadmium, nickel-metal hydride battery, etc., such as any 3V-12-volt DC battery 136 or other conventional battery 136 such as A, AA, AAA, etc., that supplies power to the device 100. Throughout this specification the terms “battery” and “batteries” may be used interchangeably to refer to one or more wet or dry cells or batteries 136 of cells in which chemical energy is converted into electricity and used as a source of DC power. References to recharging or replacing batteries 136 may refer to recharging or replacing individual cells, individual batteries 136 of cells, or a package of multiple battery cells as is appropriate for any given battery 136 technology that may be used. In one embodiment, the battery may be recharged via a charging port 139. The charging port 139 may be any charging port known in the art such as, but not limited to, USB-A, USB-B, Micro-B, Micro-USB, Mini-USB, USB-C, or a 9v/12v power supply.

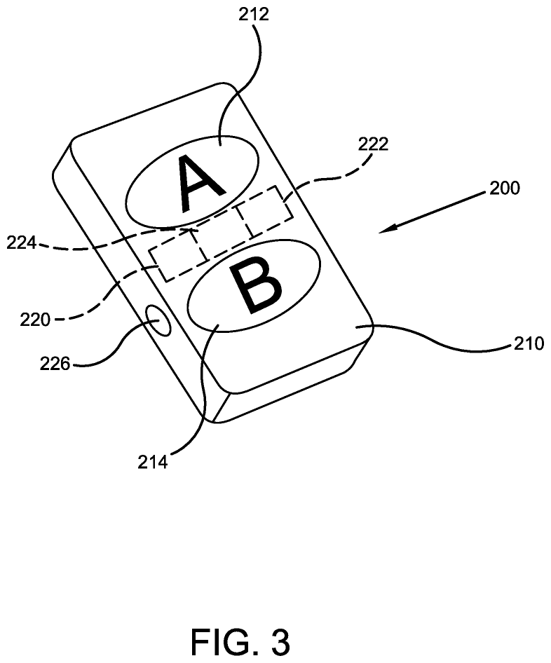

FIG. 3 illustrates a perspective view of one potential embodiment of a remote 200 for a trackable cup device 100 of the present invention in accordance with the disclosed architecture. The device 100 is comprised of at least one remote 200 comprised of at least one recording button 212, at least one location button 214, at least one transmitter 220, at least one battery 222, at least one microphone 224, and at least one charging port 226.

The body 210 is preferably manufactured form a durable rigid plastic such as, but not limited to: acrylic, polycarbonate, polyethylene, thermoplastic, acrylonitrile butadiene styrene, low-density polyethylene, medium-density polyethylene, high-density polyethylene, polyethylene terephthalate, polyvinyl chloride, polystyrene, polylactic acid, acetal, nylon, fiberglass, recycled plastic, biodegradable plastic, etc. The body 210 further may be manufactured in any shape known in the art, but in the preferred embodiment it is rectangular in shape.

The remote 200 is comprised of at least one transmitter 220. The transmitter 220 may be any transmitter known in the art. Further, the transmitter 220 is in electrical communication with the receiver 134. In different embodiments the electronical communication capabilities of the device 100 could be but not limited to: GPS, WIFI, Bluetooth, RFID, cellular, etc. The remote 200 further is comprised of at least one recording button 212. The recording button 212 when pressed, makes the transmitter 220 electrically communicate with the receiver 134 that the button has been pressed. The receiver 134 then communicates with the speaker 138, which then plays a prerecorded audio sound through the speakers 138. The audio sound may be recorded via at least one microphone 224 positioned in the remote 200. The microphone 224 and the recording feature allow a parent to be able to record anything they wish to play through the device 100. That way the device could play a prerecorded soothing sound to the child in order to calm the child.

The remote 200 may also be comprised of at least one location button 214. The location button 214 when pressed, communicates with the device 100 via transmitter 220 and receiver 134. The device 100 then plays a sound through the speakers 138 that allows the user to follow the sound and locate the lost device 100.

The remote 200 may be comprised of at least one battery 222 that powers the remote 200. The battery 222 can be in the form of an alkaline, nickel-cadmium, nickel-metal hydride battery, etc., such as any 3V-12-volt DC battery 222 or other conventional battery 222 such as A, AA, AAA, etc., that supplies power to the remote 200. Throughout this specification the terms “battery” and “batteries” may be used interchangeably to refer to one or more wet or dry cells or batteries 222 of cells in which chemical energy is converted into electricity and used as a source of DC power. References to recharging or replacing batteries 222 may refer to recharging or replacing individual cells, individual batteries 222 of cells, or a package of multiple battery cells as is appropriate for any given battery 222 technology that may be used. In one embodiment, the battery may be recharged via a charging port 226. The charging port 226 may be any charging port known in the art such as, but not limited to, USB-A, USB-B, Micro-B, Micro-USB, Mini-USB, USB-C, or a 9v/12v power supply.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “trackable cup device” and “device” are interchangeable and refer to the trackable cup device 100 of the present invention.

Notwithstanding the foregoing, the trackable cup device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the trackable cup device 100 as shown in the FIGS. are for illustrative purposes only, and that many other sizes and shapes of the trackable cup device 100 are well within the scope of the present disclosure. Although the dimensions of the trackable cup device 100 are important design parameters for user convenience, the trackable cup device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A trackable cup device comprising:
a body;
a top member having an opening;
a nozzle positioned on the top member;
a base member;
a speaker;
a receiver; and
a remote comprised of a transmitter.

2. The trackable cup device of claim 1, wherein the top member is further comprised of a fastener.

3. The trackable cup device of claim 2, wherein the fastener is attached to a reciprocating fastener positioned on the body.

4. The trackable cup device of claim 3, wherein each of the fastener and the reciprocating fastener is a threaded fastener, a snap-cap fastener, a magnetic fastener or an adhesive fastener.

5. The trackable cup device of claim 1, wherein the top member is comprised of a valve.

6. The trackable cup device of claim 1 further comprising a battery positioned on the base member.

7. The trackable cup device of claim 1, wherein the base member is comprised of a base member fastener.

8. The trackable cup device of claim 7, wherein the base member fastener is attached to a reciprocating base member fastener positioned on the body.

9. The trackable cup device of claim 1, wherein the remote further comprises a battery.

10. A trackable cup device comprising:
a body;
a top member having an opening;
a nozzle;
a fastener;
a base member;
a speaker;
a battery;
a receiver; and
a remote, wherein the remote comprises a transmitter, a battery and a microphone.

11. The trackable cup device of claim 10, wherein the remote further comprises a recording button.

12. The trackable cup device of claim 10, wherein the remote further comprises a location button.

13. The trackable cup device of claim 10, wherein the top member further comprises a cap.

14. The trackable cup device of claim 13, wherein the cap is comprised of a hinge.

15. The trackable cup device of claim 13, wherein the cap is comprised of a fastener.

16. The trackable cup device of claim 13, wherein the cap is comprised of a button.

17. A trackable cup device comprising:
a body having a grip area;
a top member comprised of a nozzle, a fastener, a valve, a gasket and an opening;
a base member comprised of a speaker, a battery, a receiver, a fastener; and
a remote comprised of a transmitter, a battery, a recording button, a location button and a microphone.

18. The trackable cup device of claim 17, wherein a bottom surface of the base member is comprised of a non-slip grip area.

19. The trackable cup device of claim 17, wherein the remote is further comprised of a charging port.

20. The trackable cup device of claim 17, wherein the base member is further comprised of a charging port.
